(19) United States
(12) Patent Application Publication
(10) Pub. No.: US 2009/0239978 A1
(43) Pub. Date: Sep. 24, 2009

(54) Melamine resin

(75) Inventors: Steffen Pfeiffer, Linz (AT); Werner Deutschbauer, Enns (AT); Roland Raninger, Linz (AT)

Correspondence Address: THE WEBB LAW FIRM, P.C., 700 KOPPERS BUILDING, 436 SEVENTH AVENUE, PITTSBURGH, PA, 15219, US

(73) Assignee: AMI AGROLINZ MELAMINE INTERNATIONAL GMBH, Linz (AT)

(21) Appl. No.: 11/922,437

(22) PCT Filed: Jun. 19, 2006
(86) PCT No.: PCT/EP2006/006185

§ 371 Date: Dec. 18, 2007

(30) Foreign Application Priority Data
Jun. 20, 2005 (DE) 10 2005 029 683.1

(51) Int. Cl. C08L 97/02; C08G 12/32; C08L 61/28; C08K 5/3492; C08K 5/29; C08L 1/02

(52) U.S. Cl. 524/13; 528/254; 524/597; 524/101; 524/195; 524/35

(57) ABSTRACT

The invention relates to melamine resin, wherein it is, in essence, linearly synthesized and is dependent upon the viscosity of the rate of shear. The invention also relates to a method for producing the melamine resin and to the use thereof.

The invention relates to a melamine resin as claimed in the precharacterizing part of claim 1, to a process for its preparation as claimed in claim 20, and to its use as claimed in claim 23.

Partially crosslinked melamine resins processable in the melt phase are known. These are melamine resins in which the primary condensates composed of melamine and formaldehyde have been etherified using alcohols. The properties of these partially crosslinked melamine resins, e.g. flow behavior and melting behavior, are affected here by the corresponding preparation processes, by the alcohols used for etherification, by the degrees of polymerization and of crosslinking associated therewith, and by the fillers and additives usually added to the resins.

WO 03/046053 describes molding compositions composed of melamine resins etherified using alcohols, but although these resins are suitable in principle for thermoplastic processing methods they have very little thermoplastic processing latitude. This means that, even before the melting process is complete, the final hardening of the resins often begins in the shaping die.

Wo 03/106558 likewise relates to molding compositions composed of melamine resins transetherified using alcohols. They are produced via etherification of melamine-aldehyde precondensates using low-molecular-weight alcohols, followed by transetherification using relatively high-molecular-weight alcohols. The crosslinked resins thus prepared have good melting behavior, and this means that there is sufficient processing latitude between their melting point and the temperature of onset of hardening.

A disadvantage of the known etherified melamine resins is that they have a high degree of crosslinking and therefore have relatively high viscosity even in the melt. When fillers are incorporated, the viscosity increases further, and it is therefore almost impossible to achieve homogeneous dispersion of the fillers in the resin. Furthermore, the high viscosity gives the resin melt poor flow behavior in the process tooling.

WO 2005/010097 describes one approach to increasing the flexibility of melamine resin molding compositions. Here, a crosslinked melamine resin ether is mixed with a crosslinked thermoplastic. Crosslinked thermoplastics, such as an ethylene-vinyl acetate copolymer or an ethylene-acrylate copolymer, act as lubricants and thus improve the flow behavior of the molding compositions. A disadvantage here is that the addition of thermoplastics impairs the mechanical properties of the molding compositions.

A problem underlying the invention is therefore to provide a partially crosslinked melamine resin which has good flow behavior but at the same time has good mechanical properties.

This object is achieved via provision of a melamine resin with the features of claim 1.

The inventive melamine resin is characterized in that it in essence has linear structure, and its viscosity is dependent on the shear rate.

The melamine resins which in essence have linear structure take the form of linear or weakly crosslinked chain molecules. At sufficiently high temperature, these chain molecules can slide over one another, making the melamine resin fusible and thermoplastically processable. Surprisingly, the viscosity of the resin melt of the melamine resins is dependent on the shear rate, and this is termed non-Newtonian behavior. As shear rate rises, the viscosity of the resin melt falls. This means that in the melt phase the melamine resins have very good flow behavior, and distribute themselves in an excellent manner in the shaping die, and also that the viscosity remains sufficiently low when proportions of filler are high, thus permitting homogeneous distribution of the fillers in the resin matrix. The inventive melamine resins therefore have a unique combination of thermoplastic and thermoset properties. The melamine resins can also be termed easy-flow melamine resins.

The melamine resin which in essence has linear structure and whose viscosity is dependent on shear rate is composed of triazine rings which have monosubstituted amino groups and have bisubstituted amino groups, where the triazine rings have linkage by way of the monosubstituted amino groups by means of condensation and/or etherification. The linkage by way of the monosubstituted amino groups gives a loose, in essence linear network.

Advantageously, the molecular weights of the melamine resins range from 1500 to 200 000. The molecular weight distribution is wide.

It is particularly preferable that the weight-average molecular weight (M_{w}) of the melamine resins is greater than 5000, where the weight-average molecular weight is determined from

$${M}_{w} = \frac{{\sum }_{i} {N}_{i} {M}_{i}^{2}}{{\sum }_{i} {N}_{i} {M}_{i}} \qquad ( 1 )$$

where Nᵢ is the number of molecules of molecular weight Mᵢ, and Mᵢ is the molecular weight of molecule type i.

The preferred melamine/formaldehyde mole ratio of the melamine resins is from 1:3 to 1:5. The inventive melamine resins differ from the known etherified melamine resins via their relatively high formaldehyde content.

The melamine/formaldehyde ratio during the synthesis of the precondensate has a decisive effect on the degree of precrosslinking of the melamine resins. Given a molar melamine/formaldehyde ratio of 1:≦3, there is preferential formation of monosubstituted amino groups on the melamine ring, and indeed there are even unsubstituted NH₂ groups present. A large number of monosubstituted and unsubstituted amino groups, as in the known etherified melamine resins, leads to relatively strong crosslinking and linkage of the melamine rings via autocondensation and/or etherification, thus forming undesirably rigid, solid, and branched networks.

In contrast, the present melamine-formaldehyde ratio in the melamine resins achieves substitution of all of the amino groups of the melamine, the result being that no residual free NH₂ groups, with their tendency toward autocondensation, are present in the melamine. Furthermore, there is more bisubstitution of the amino groups, the result being that only relatively few monosubstituted amino groups are present and are available for subsequent reactions. This gives a loose network of high flexibility having linear structures.

It is preferable that the triazine rings present in the melamine resin and of the type represented by (B₂N)_{b}—X—(NHA)ₐ, where a+b=3 and 0≦b≦2, X is a triazine ring, and each of A and B is a —CH₂OR group having a moiety R composed of any desired alkanol, diol or polyol, are formed via etherification of the methylol groups of the melamine using alkanols and subsequent transetherification of the primarily etherified groups using diols and/or polyols. The chain lengths, and therefore the degree of crosslinking of the melamine resins, can be influenced by way of the choice of the alkanols, diols, and polyols.

Advantageously, C₁-C₄ alkanols are used, in particular methanol, or else polyesterdiols, butanediols, or polyetherdiols. The ratio of alkanol to diol and/or polyol here is in the range from 8:1 to 1:1, preferably from 4:1 to 2:1. Using these alcohols, good conversions are achieved simultaneously with good resin properties.

Advantageously, the transetherification is carried out at pH≧7.0. A pH in the basic region ensures that it is almost exclusively the monosubstituted methoxy groups that react with the diols and polyols, and thus promotes production of the linear structures.

The transetherification of the primarily etherified groups is advantageously carried out in the temperature range from 150° C. to 250° C. A preferred residence time for the transetherification is from 0.5 to 15 min. The reaction here proceeds more slowly at low temperatures and more quickly at high temperatures.

It is also advantageous that additives are admixed with the melamine resin, in particular flame retardants, pigments, stabilizers, catalysts, UV absorbers, and/or free-radical scavengers.

Addition of fillers to the melamine resins is moreover advantageous. Fillers used in particular comprise those of the type represented by melamine, urea, cellulose, wood, urea-formaldehyde resins, melamine-formaldehyde resins, polyether polyols and/or polyester polyols. The urea-formaldehyde resins and melamine-formaldehyde resins used as fillers here can be in completely etherified, partially etherified, and unetherified form.

Additives and fillers are added to the melamine resins in order to achieve specific resin properties, such as toughness, elasticity, color, and electrical properties. Additive and filler amounts of up to 80% are possible in advantageous embodiments of the melamine resins.

In one preferred embodiment, the glass transition temperature of the melamine resin is above 35° C. The weight-average molecular weight M_{w} here is usually greater than 5000. This type of melamine resin has particularly good properties in relation to storability, miscibility, and processability.

The object of the invention is also achieved via a process for preparation of a melamine resin as claimed in claim 1, and its use.

In the invention, the melamine resin is prepared by a process in which an etherified melamine resin containing triazine rings of the type represented by (B₂N)_{b}—X—(NHA)ₐ, where a+b=3 and 0≦b≦2, X is a triazine ring, and each of A and B is a —CH₂OR group having an alkanol moiety R is prepared in a first step from melamine, formaldehyde, and alkanol, in an acidic medium.

The pH of the melamine resin solution is then set to ≧7, and the concentration of the melamine resin is increased to give the resin melt. This takes place, for example, in one or more thin-film evaporators.

The melamine resin melt is then transetherified using diols and/or polyols at from 150 to 250° C., whereupon the melamine resin is cooled and finished. The melamine resin is usually obtained in the form of granules.

It is preferable that the transetherification takes place continuously in the extruder or residence-time reactor, or batchwise in the kneader. It is usual that relatively high temperatures and relatively low residence times prevail in the extruder, and that relatively low temperatures and relatively high residence times prevail in the residence-time reactor.

Advantageously, the diols and/or polyols used for the transetherification are added prior to, during, or after the increase of concentration. The additives and fillers are preferably added after the transetherification. At this point, the good flowability and the good wettability of the melamine resin melt allows them to be mixed particularly homogeneously with the resin.

The melamine resins are used for preparation of molding compositions for processing in the melt and for production of composite materials, in particular wood-based composite materials. Very good wetting of the wood particles and excellent flow behavior in the shaping die are achieved in the wood-based composite materials using the inventive melamine resins.

The melamine resins can moreover be used for production of sheets, of tubes, of profiles, of injection-molded parts, of fibers, and of foams, and also for processing from solution or dispersion in the form of adhesive, impregnation resin, surface-coating resin or lamination resin, or for production of foams, or of microcapsules or fibers.

The use of the inventive melamine resins is generally advantageous wherever corresponding rheology is desirable. This is the case, for example, in injection-molding applications, or if large amounts of fillers have to be incorporated into the melamine resins.

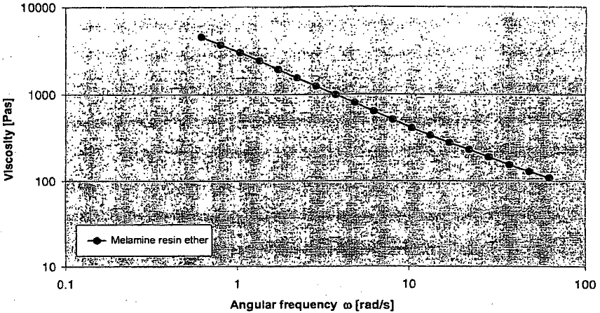

The invention is explained in more detail below with reference to FIG. 1 and to a number of inventive examples.

FIG. 1: shows a graph describing the viscosity of the melamine resin ether as a function of shear.

### 1. PREPARATION OF THE ETHERIFIED MELAMINE-FORMALDEHYDE PRECONDENSATE

### Example 1

For preparation of the precondensate, 15.55 kg of melamine, 38.48 kg of 50% strength methanolic formaldehyde solution, 65 g of p-toluenesulfonic acid, and 38.74 kg of methanol are metered into a 100 l stirred reactor. The mixture is heated within a period of 20 min to 95° C. and, once a clear solution has been obtained, stirred at this temperature for a further 40 min. After cooling to room temperature, 30% methanolic KOH is used to adjust pH to 7.7. 13.44 kg of Simulsol BPPE (Seppic) are added to this mixture. The solution is then continuously concentrated by way of two thin-film evaporators as far as a residual solvent content of <5% by weight.

### Example 2

For preparation of the precondensate, 15.55 kg of melamine, 31.22 kg of 50% strength methanolic formaldehyde solution, 65 g of p-toluenesulfonic acid, and 41.96 kg of methanol are metered into a 100 l stirred reactor. The mixture is heated within a period of 20 min to 95° C. and, once a clear solution has been obtained, stirred at this temperature for a further 40 min. After cooling to room temperature, 30% methanolic KOH is used to adjust pH to 7.6. 0.8 kg of 1,4-butanediol is added to this mixture. The solution is then continuously concentrated by way of two thin-film evaporators as far as a residual solvent content of <5% by weight.

### Example 3

For preparation of the precondensate, 15.55 kg of melamine, 40 kg of 37% strength formaldehyde solution, 65 g of p-toluenesulfonic acid, and 55.23 kg of methanol are metered into a 100 l stirred reactor.

The mixture is heated within a period of 20 min to 90° C. and, once a clear solution has been obtained, stirred at this temperature for a further 50 min. After cooling to room temperature, 30% methanolic KOH is used to adjust pH to 10. 1.6 kg of 1,4-butanediol are added to this mixture. The solution is then continuously concentrated by way of two thin-film evaporators as far as a residual solvent content of <5% by weight.

### Example 4

For preparation of the precondensate, 15.55 kg of melamine, 19.24 kg of paraformaldehyde, 65 g of p-toluenesulfonic acid, and 58 kg of methanol are metered into a 100 l stirred reactor. The mixture is heated within a period of 20 min to 100° C. and, once a clear solution has been obtained, stirred at this temperature for a further 65 min. After cooling to room temperature, 30% methanolic KOH is used to adjust pH to 10.5. 1.8 kg of trimethylolpropane are added to this mixture. The solution is then continuously concentrated by way of two thin-film evaporators as far as a residual solvent content of <5% by weight.

### 2.a Production of Melamine Resin (Easy-Flow Melamine Resin) Via Transetherification in the Extruder

The transetherification and further condensation to give the easy-flow melamine resin takes place in the LD=48 ZSK 30 extruder with vacuum devolatilization (Werner &. Pfleiderer) with an average residence time of from 0.5 to 2 min. 10-12 kg/h of the etherified melamine-formaldehyde precondensates from examples 1 and, respectively, 2 are metered into the feed zone of the extruder. The extrudate of the polytriazine ether is finished in a roll granulator.

The viscosity of the resultant easy-flow melamine resin is from 2 to 200 Pa*s at 130° C. and its diol conversion is from to 80%, determined via HPLC or GC.

### Example 5

The temperature profile in the extruder during the transetherification of the precondensate using Simulsol BPPE from example 1 is shown below:

| Zone | 1 | 2 | 3 | 4 | 5 | 6 | 7 | 8 | 9 | 10 | 11 | 12 | Fl./die |
|---|---|---|---|---|---|---|---|---|---|---|---|---|---|
| T [° C.] | 180 | 180 | 225 | 225 | 225 | 225 | 225 | 225 | 225 | 190 | 130 | 110 | 110 |

The viscosity of the easy-flow resin produced under these conditions is 2 Pa*s at 130° C., with diol conversion of 65% (HPLC).

### Example 6

The temperature profile in the extruder during the transetherification of the precondensate using 1,4-butanediol from example 2 is shown below:

| Zone | 1 | 2 | 3 | 4 | 5 | 6 | 7 | 8 | 9 | 10 | 11 | 12 | Fl./die |
|---|---|---|---|---|---|---|---|---|---|---|---|---|---|
| T [° C.] | 180 | 180 | 210 | 210 | 210 | 210 | 210 | 210 | 210 | 160 | 110 | 110 | 110 |

The viscosity of the easy-flow resin produced under these conditions is 120 Pa*s at 130° C., with diol conversion of 75% (GC). The glass transition temperature. T_{g} of the melamine resin is 41° C.

### Example 7

The temperature profile in the extruder during the transetherification of the precondensate using 1,4-butanediol from example 3 is shown below:

| Zone | 1 | 2 | 3 | 4 | 5 | 6 | 7 | 8 | 9 | 10 | 11 | 12 | Fl./die |
|---|---|---|---|---|---|---|---|---|---|---|---|---|---|
| T [° C.] | 180 | 210 | 210 | 210 | 210 | 210 | 210 | 210 | 180 | 160 | 110 | 110 | 110 |

The viscosity of the easy-flow resin produced under these conditions is 30 Pa*s at 130° C., with diol conversion of 63% (GC). The glass transition temperature T_{g} of the melamine resin is 36° C. The weight-average molar mass of the melamine resin is 9000 g/mol.

### Example 8

The temperature profile in the extruder during the transetherification of the precondensate using 1,4-butanediol from example 2 is shown below:

| Zone | 1 | 2 | 3 | 4 | 5 | 6 | 7 | 8 | 9 | 10 | 11 | 12 | Fl./die |
|---|---|---|---|---|---|---|---|---|---|---|---|---|---|
| T [° C.] | 180 | 180 | 200 | 200 | 250 | 250 | 250 | 200 | 200 | 180 | 160 | 110 | 125 |

The viscosity of the easy-flow resin produced under these conditions is 200 Pa*s at 130° C., with diol conversion of 67% (GC). The glass transition temperature T_{g} of the melamine resin is 47° C. The weight-average molar mass of the melamine resin is 15 000 g/mol.

### Example 9

The temperature profile in the extruder during the transetherification of the precondensate using trimethylolpropane from example 4 is shown below:

| Zone | 1-3 | 4 | 5 | 6 | 7 | 8 | 9 | 10 | 11 | 12 | 13 | 14 | 15-16 | Fl./die |
|---|---|---|---|---|---|---|---|---|---|---|---|---|---|---|
| T [° C.] | 135 | 250 | 250 | 250 | 250 | 250 | 250 | 250 | 250 | 170 | 140 | 150 | 135 | 125 |

The viscosity of the easy-flow resin produced under these conditions is 1500 Pa*s at 100° C., with triol conversion of 70% (GC). The glass transition temperature T_{g} of the melamine resin is 37° C. The weight-average molar mass of the melamine resin is 35 000 g/mol.

### 2.b Production of Melamine Resin (Easy-Flow Melamine Resin) Via Transetherification in the Residence-Time Reactor and Extruder

The transetherification and further condensation of the precondensates to give the easy-flow resin takes place in a residence-time reactor using an average residence time of from 5 to 10 min, and temperatures of from 150 to 200° C., at a pressure of 200-500 mbar. This melt is then metered into the feed zone of the extruder. The extrudate of the polytriazine ether is finished in a roll granulator.

### Example 10

The transetherification using 1,4-butanediol as in example 3 takes place in a residence-time reactor for a period of 5 min and at a temperature of 160° C. The material is subsequently metered in an extruder with the following temperature profile:

| Zone | 1 | 2 | 3 | 4 | 5 | 6 | 7 | 8 | 9 | 10 | 11 | 12 | Fl./die |
|---|---|---|---|---|---|---|---|---|---|---|---|---|---|
| T [° C.] | 150 | 150 | 200 | 240 | 240 | 240 | 200 | 160 | 160 | 130 | 110 | 110 | 110 |

The viscosity of the easy-flow resin produced under these conditions is 70 Pa*s at 130° C., with diol conversion of 72% (GC). The glass transition temperature T_{g} of the melamine resin is 45° C. The weight-average molar mass of the melamine resin is 25 000 g/mol.

### Example 11

The transetherification using 1,4-butanediol as in example 3 takes place in a residence-time reactor for a period of 7 min and at a temperature of 160° C. The material is subsequently metered in an extruder with the following temperature profile:

| Zone | 1 | 2 | 3 | 4 | 5 | 6 | 7 | 8 | 9 | 10 | 11 | 12 | Fl./die |
|---|---|---|---|---|---|---|---|---|---|---|---|---|---|
| T [° C.] | 150 | 150 | 200 | 245 | 245 | 245 | 200 | 160 | 160 | 130 | 120 | 120 | 120 |

The viscosity of the easy-flow resin produced under these conditions is 100 Pa*s at 130° C., with diol conversion of 76% (GC). The glass transition temperature T_{g} of the melamine resin is 48° C.

It can be seen that the viscosity and the glass transition temperature of the inventive melamine resins (easy-flow melamine resins) can be influenced via the various parameters, such as amount of diol or amount of polyol, and temperature adjustment and residence time in the residence-time reactor and extruder. The glass transition temperature here is a measure of the linearity and uniformity of the easy-flow resin. The higher the glass transition temperature for a given weight-average molecular weight, the more linear the structure of the melamine resin.

FIG. 1 shows a typical functional relationship between viscosity and shear rate, measured at 130° C., for one embodiment of the inventive melamine resins. It can be seen that the prevailing dependency of viscosity on shear rate is almost linear within the shear range tested, and this is termed “non-Newtonian behavior”.

1-23. (canceled)

24. A partially crosslinked melamine resin, prepared from triazine rings which have monosubstituted amino groups and have bisubstituted amino groups, wherein the triazine rings have linkage by way of the monosubstituted amino groups by means of condensation or etherification or both,
wherein the melamine/formaldehyde molar ratio used (of the melamine resin) is from 1:3 to 1:5, and alkanols and at least one of diols or polyols are used in an alkanol:diol or alkanol:polyol ratio of from 8:1 to 1:1,
wherein the melamine resin in essence has linear structure, and its viscosity is dependent on the shear rate.

25. The melamine resin as claimed in claim 24, wherein the melamine resin is prepared from triazine rings of the type represented by (B₂N)_{b}—X—(NHA)ₐ, where a+b=3 and 0≦b≦2, X is a triazine ring, and each of A and B is a —CH₂OR group having a moiety R composed of any desired alkanol, diol or polyol.

26. The melamine resin as claimed in claim 24, wherein the molecular weights of the melamine resin are from 1500 to 200 000.

27. The melamine resin as claimed in claim 24, wherein the weight-average molecular weight M_{w} of the melamine resin is greater than 5000.

28. The melamine resin as claimed in claim 25, wherein the triazine rings of the type represented by (B₂N)_{b}—X—(NHA)ₐ present in the melamine resin are formed by means of etherification of methylol groups of the melamine with alkanols and subsequent transetherification of the primarily etherified groups with diols or polyols or both.

29. The melamine resin as claimed in claim 28, wherein the transetherification is carried out at a pH greater than or equal to 7.0.

30. The melamine resin as claimed in claim 24, wherein the alkanols are C₁-C₄ alkanols.

31. The melamine resin as claimed in claim 24, wherein the diols are polyesterdiols, butanediol, or polyetherdiols.

32. The melamine resin as claimed in claim 31, wherein the alkanol:diol or alkanol:polyol ratio is from 4:1 to 2:1.

33. The melamine resin as claimed in claim 28, wherein the transetherification of the primarily etherified groups takes place in the temperature range from 150° C. to 250° C.

34. The melamine resin as claimed in claim 28, wherein the residence time during the transetherification of the primarily etherified groups is from 0.5 to 15 min.

35. The melamine resin as claimed in claim 24, wherein the melamine resin comprises additives or fillers or both.

36. The melamine resin as claimed in claim 35, wherein the additives are at least one of flame retardants, pigments, stabilizers, catalysts, UV absorbers, or free-radical scavengers.

37. The melamine resin as claimed in claim 35, wherein the fillers are at least one of melamine, urea, cellulose, wood, urea-formaldehyde resins, melamine-formaldehyde resins, polyether polyols, or polyester polyols.

38. The melamine resin as claimed in claim 37, wherein urea-formaldehyde resins and melamine-formaldehyde resins used as fillers can be in completely etherified, partially etherified, or unetherified form.

39. The melamine resin as claimed in claim 24, wherein the glass transition temperature of the melamine resin is above 35° C.

40. A process for preparation of a melamine resin as claimed in claim 24, comprising the steps of:
preparing etherified melamine resin containing triazine rings of the type represented by (B₂N)_{b}—X—(NHA)ₐ, where a+b=3 and 0≦b≦2, X is a triazine ring, and each of A and B is a —CH₂OR group having an alkanol moiety R, from melamine, formaldehyde, and alkanol in an acidic medium,
setting the pH to ≧7,
increasing the concentration of the etherified melamine resin to give a melt, wherein, at from 150 to 250° C., the etherified melamine resin is transetherified using diols or polyols or both, and
cooling and finishing the melamine resin.

41. The process for preparation of a melamine resin as claimed in claim 40, wherein the transetherification is carried out continuously in an extruder or residence-time reactor or batchwise in a kneader.

42. The process for preparation of a melamine resin as claimed in claim 40, wherein the diols or polyols or both are added prior to, during, or after the increase of concentration, and the additives or fillers or both are added after the transetherification.

43. A wood-based composite material, encompassing a melamine resin as claimed in claim 24 and wood particles.
